(19) United States
(12) Patent Application Publication
(10) Pub. No.: US 2002/0020503 A1
(43) Pub. Date: Feb. 21, 2002

(54) Unistage drum for producing a farm vehicle radial tire

(76) Inventor: Farinola Luca, Rome (IT)

Correspondence Address: John H. Hornickel, Chief Intellectual Property Counsel, Bridgestone/Firestone, Inc., 1200 Firestone Parkway, Akron, OH, 44317-0001, US

(21) Appl. No.: 09/904,677

(22) Filed: Jul. 13, 2001

(30) Foreign Application Priority Data
Jul. 13, 2000 (IT) TO 2000 A 000700

(51) Int. Cl. B29D 30/24

(52) U.S. Cl. 156/416

(57) ABSTRACT

A unistage drum (1) for producing an agricultural tire (2), the drum (1) having a fixed central body (16) for supporting a relatively thin central portion (11) of the carcass (3) of the tire (2), and two movable half-drums (15) located on opposite sides of the central body (16) to support respective thicker lateral portions (12) of the carcass (3). Each half-drum (15) has a respective expandable bead clamping device (23), and is, at least along a portion projecting outwards of the relative bead clamping device (23), of a diameter (D2) smaller than the diameter (D1) of the central body (16) so as to compensate for the differences in thickness between the central portion (11) and the lateral portions (12) of the carcass (3).

### FIELD OF THE INVENTION

The present invention relates to a unistage drum for producing a farm vehicle radial tire.

### BACKGROUND OF THE INVENTION

Agricultural radial tires are normally produced using a two-stage method whereby the tire is formed on a first- and a second-stage drum in succession. The first-stage drum is normally a cylindrical, radially collapsible drum having, when extended, an outside diameter greater than the inside diameter of the metal bead bundles of the tire being produced.

In the two-stage method, the first-stage drum includes an innerliner having two abrasion strips extending on opposite sides thereof and so positioned as to each project partly from a respective annular end surface of the first-stage drum. A number of body plies, each normally reinforced with textile cords, is centered with respect to the innerliner and covers both the innerliner and the abrasion strips. The body plies project from the two annular end surfaces of the first-stage drum. At this point, the portions of the abrasion strips and body plies projecting from the two end surfaces of the first-stage drum are gathered for insertion inside two bead bundles which are slid into contact with the respective end surfaces of the first-stage drum. The portions of the body plies and abrasion strips projecting outwards of the two bead bundles are then turned up about the bead bundles and onto the outside of the first-stage drum by means of external turn-up devices. The carcass is completed by laying a sidewall strip on the outside of each turned-up portion, which is connected to an outer free edge of the respective abrasion strip.

The finished carcass has a substantially C-shaped section, and is removed from the first-stage drum by collapsing the first-stage drum to a diameter smaller than the inside diameter of the carcass (i.e. the inside diameter of the bead bundles less twice the thickness of the turned-up portions). The carcass is then mounted onto a second-stage drum comprising two rings, which are movable towards each other, support respective beads of the carcass, and have an outside diameter approximately equal to but no larger than the inside diameter of the carcass beads.

On the second-stage drum, the carcass is shaped by moving the two rings towards each other and, at the same time, pumping compressed air into the carcass to expand the carcass centrally into contact with a strip coaxial with the second-stage drum and comprising an inner portion defined by a pack of tread plies, and an outer portion defined by a tread strip.

Though more complicated than a unistage method—whereby the tire is assembled and shaped on a single building drum—the two-stage method is normally preferred when producing agricultural tires, on account of the high degree of expansion the carcasses of such tires undergo during shaping. The two-stage method, in fact, enables the carcass to be formed on a first-stage drum having an outside diameter greater than the inside diameter of the bead bundles, whereas the unistage method automatically calls for a building drum having an outside diameter necessarily smaller than the inside diameter of the bead bundles less the thickness of the layers inserted inside the bead bundles. In other words, using the two-stage method, not only is the carcass expanded from a greater original diameter with respect to the unistage method, but the length, and hence the number of cords of the body ply used, are greater than those of the body ply used in the unistage method.

This is confirmed in TABLE I below, which compares various characteristics of the same tire formed using the unistage and two-stage methods.

TABLE I

| | First stage drum | | Unistage drum | | Unistage drum | |
|---|---|---|---|---|---|---|
| | diameter | | diameter | | variation | |
| Drum diameter | 101.60 | cm | 86.36 | cm | 86.36 | cm |
| Type of ply | DN027 | | DN027 | | DH044 | |
| Cord diameter | 0.66 | mm. | 0.66 | mm. | 0.66 | mm. |
| Cord density | 10.2 | per cm | 10.2 | per cm | 11 | per cm |

| | | | |
|---|---|---|---|
| No. of cords | 3267 | 2778 | 2991 |
| Loss | | 15% | 8.5% |

TABLE I applies to an agricultural tire with 38.5 in. (97.8 cm) inside diameter bead bundles. Because the flat carcass formed on a unistage drum comprises a relatively thin central portion and two much thicker lateral portions on account of the sidewalls—which, in agricultural tires are relatively thick (in the tire considered, the difference in thickness between each lateral portion and the central portion of the carcass is normally about 2-3 cm)—the above tire calls for a 34 in. (86.36 cm) outside diameter unistage drum to prevent interference, when assembling the bead bundles, with the layers of material laid on the drum and defining the relative lateral portions of the carcass.

As shown in TABLE I, using a DNO27 type body ply with 0.026 in. (0.66 mm) diameter textile cords and a density of 26 cords per inch (about 10.2 per 15 cm), the total number of cords in the tire is reduced by 15% from 3267 to 2777 using a 34 in. (86.36 cm) outside diameter unistage drum, as opposed to a 40 in. (101.60 cm) outside diameter first-stage drum.

In short, TABLE I shows that, for a given type of material, the cord density at the shoulders of the tire formed on the unistage drum is low enough for the innerliner to possibly penetrate between the body ply cords, thus resulting in cutting of the innerliner, fractures spreading between the body ply cords, and impaired shock resistance of the tire.

Finally, TABLE I also shows that, replacing the DNO27 body ply with one of the same cord diameter and maximum possible cord density, i.e. a DNO27 ply with 28 cords per inch (about 11 per cm), the unistage drum described above produces a tire with a total number of 2991 cords and a loss of 8.5% with respect to the corresponding first-stage drum tire. Though undoubtedly less than before, such a loss is still sufficient to cause the same problems.

### SUMMARY OF THE INVENTION

It is an object of the present invention to provide a unistage drum for producing agricultural tires, and which provides for maintaining the above loss within acceptable values.

According to the present invention, there is provided a unistage drum for producing a farm vehicle radial tire; the tire comprising a carcass having a relatively thin central portion and two thicker lateral portions; the drum comprising a fixed central body for supporting the central portion of said carcass and having a first outside diameter, and two half-drums, each for supporting a respective said lateral portion of said carcass; and wherein said half-drums are located on opposite sides of said central body and are movable axially to and from the central body; and each said half-drum comprises an expandable bead clamping device adjacent to said central body; wherein at least one portion of each said half-drum extending outwards with respect to the relative said bead clamping device has a second diameter smaller than said first diameter to at least compensate for the differences in thickness between said central portion and said lateral portions of said carcass when the carcass is laid flat on the drum.

In particular, the present invention relates to a unistage drum for producing a farm vehicle radial tire comprising a carcass having a relatively thin central portion and two thicker lateral portions; the drum comprising a fixed central body for supporting the central portion of the carcass and having a given outside diameter, and two half-drums, each for supporting a respective lateral portion of the carcass; wherein the half-drums are located on opposite sides of the central body and are movable axially to and from the central body; and each half-drum comprises an expandable bead clamping device adjacent to the central body.

### BRIEF DESCRIPTION OF THE DRAWINGS

A non-limiting embodiment of the invention will be described by way of example with reference to the accompanying drawing, in which:

FIG. 1 shows an axial section of a portion of a preferred embodiment of the drum according to the invention.

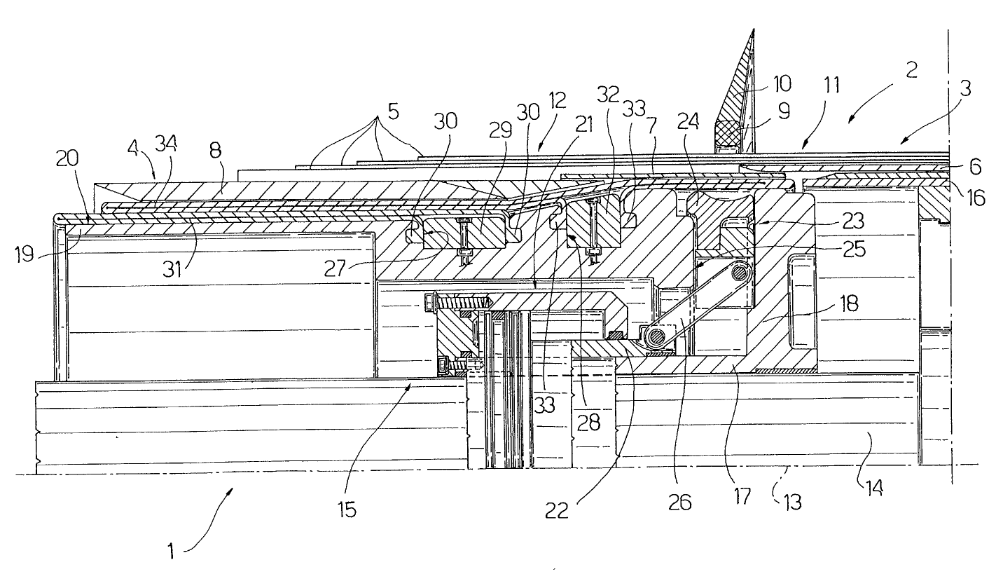

### EMBODIMENT OF THE INVENTION

Number 1 in the accompanying drawing indicates as a whole a unistage drum for producing an agricultural tire 2. Tire 2 includes a carcass 3 (shown laid flat on drum 1), a coating skim 4 on the outer surface of drum 1, and a number of plies 5 packed one on top of the other and laid on the outer surface of coating skim 4.

Coating skim 4 comprises a central innerliner 6, two abrasion strips 7 (only one shown) located on opposite sides of and overlapping innerliner 6, and two sidewalls 8 (only one shown), each of which overlaps respective abrasion strip 7 and is thicker than innerliner 6 and abrasion strips 7.

Carcass 3 also comprises two metal bead bundles 9 (only one shown) fitted onto plies 5 at relative abrasion strip 7, and a relative substantially triangular bead filler 10 extending radially outwards from relative bead bundle 9. On the flat carcass 3, bead bundles 9 define a central portion 11 which extends between the two bead bundles 9 (shown only partly) and two lateral portions 12 (only one shown). Lateral portions 12 are located on opposite sides of central portion 11 and are turned up about respective bead bundles 9 when shaping carcass 3.

Drum 1 is mounted for rotation about a respective axis 13, and comprises a central tubular shaft 14 coaxial with axis 13 and housing a known actuating device (not shown) for moving two cylindrical half-drums 15 (only one shown) in opposite directions along shaft 14. Half-drums 15 are mounted to slide along shaft 14 coaxially with each other and with axis 13, and are connected to said actuating device (not shown) to slide in opposite directions along shaft 14 without rotating with respect to shaft 14.

Drum 1 also comprises a substantially cylindrical, fixed central body 16, which is fitted in an axially fixed position to shaft 14, is coaxial with half-drums 15, and connects half-drums 15 to each other.

Each half-drum 15 comprises a tubular central slide 17 fifted in sliding and angularly fixed manner to shaft 14 and having, at the end facing central body 16, an outer flange 18, the outer periphery of which is connected integrally to one end of a tubular body 19. Tubular body 19 is coaxial with axis 13 and has an outer surface 20 smaller in diameter than the outer surface of central body 16 by an amount specified later on.

At the opposite end to that supporting flange 18, slide 17 supports an annular hydraulic cylinder 21. Hydraulic cylinder 21 extends about shaft 14, coaxially with axis 13, and has a tubular output rod 22 facing flange 18, coaxial with axis 13, and sliding along slide 17 to and from flange 18.

Cylinder 21 defines the actuating device of a respective bead clamping device 23 comprising a number of sectors 24, each of which is mounted to slide along a respective radial passage 25 formed through flange 18, is connected at the bottom, by means of a respective connecting rod 26, to the end of tubular rod 22 facing flange 18, and is moved by hydraulic cylinder 21 between a withdrawn rest position, in which sector 24 is housed inside relative passage 25, and a partly extracted work position clamping relative bead bundle 9.

Two annular grooves 27 and 28 are formed in surface 20 of tubular body 19, with groove 28 interposed between groove 27 and bead clamping device 23. Inside groove 27, both the annular end shoes 30 of an annular thrust bladder 31 are locked removably and adjacent to each other by means of an annular insert 29; bladder 31 at rest lies on surface 20 in the opposite direction to central body 16; and insert 29 is locked removably inside groove 27 between the two shoes 30. Inside groove 28, both the annular end shoes 33 of an annular turn-up bladder 34 are locked removably and adjacent to each other by means of an annular insert 32, and bladder 34 in the deflated rest condition lies on thrust bladder 31.

As can be seen from the accompanying drawing, substantially the whole portion of half-drum 15 extending outwards of relative bead clamping device 23 and defined by tubular body 19 and by the two bladders 31 and 34 lying at rest on tubular body 19 has a diameter D2 smaller than the outside diameter D1 of central body 16, and which differs from diameter D1 by an amount at least sufficient to compensate for the differences in thickness between central portion 11 and lateral portions 12 of carcass 3, i.e. at least sufficient to impart a substantially cylindrical shape to plies 5 of the flat carcass 3.

Unlike a known unistage drum, in which the portion of each half-drum extending outwards of the relative bead clamping device has substantially the same outside diameter as the relative central body, on drum 1, lateral portions 12 of the flat carcass 3 no longer project radially outwards with respect to central portion 11. Consequently, a tire such as the one described in the introduction, i.e. having 38.5 in. (97.8 cm) inside diameter bead bundles 9, may be formed on a unistage drum 1, the diameter D1 of the central body 16 of which may be increased to 36 in. (91.44 cm), i.e. by about 5 cm, with respect to the 34 in. (86.36 cm) of a known unistage drum, with no risk of interference between bead bundles 9 and relative lateral portions 12 of the flat carcass 3 when fitting bead bundles 9 to drum 1 outwards of relative bead clamping devices 23, or between the beads of tire 2 and central body 16 when unloading the finished tire 2 off drum 1.

The advantages of using a central body 16 with a larger diameter D1 are shown clearly in TABLE II below, which is a completion of TABLE I:

TABLE II

| | Two-stage | Unistage | Unistage | Unistage | Unistage |
|---|---|---|---|---|---|
| | drum | drum | Variation | Variation | Variation |
| | diam. | diam. | I | II | III |
| Drum diam. | 101.60 | 86.36 | 86.36 | 91.44 | 91.44 |
| | cm | cm | cm | cm | cm |
| Center diam. | | 86.36 | 86.36 | 91.44 | 91.44 |
| | | cm | cm | cm | cm |
| Side diam. | | 86.36 | 86.36 | 86.36 | 86.36 |
| | | cm | cm | cm | cm |
| Type of ply | DN027 | DN027 | DH044 | DN027 | DH044 |
| Cord diam. | 0.66 | 0.66 | 0.66 | 0.66 | 0.66 |
| | mm. | mm. | mm. | mm. | mm. |
| Cord density | 10.2/cm | 10.2/cm | 11/cm | 10.2/cm | 11/cm |
| No. of cords | 3267 | 2778 | 2991 | 2940 | 3167 |
| Loss | | 15% | 8.5% | 10% | 3% |

As shown in TABLE II, if the Variation II data—relative to an agricultural tire with 38.5 in. (97.8 cm) inside diameter bead bundles, produced on a drum 1 with a central body 16 of 36 in. (91.44 cm) outside diameter D1, and using a DNO27 body ply with 0.026 in. (about 0.66 mm) diameter textile cords and a density of 26 cords per inch (about 10.2 per cm)—is compared with the data relative to the same tire having a carcass formed on a 40 in. (101.60 cm) outside diameter first-stage drum, the total number of cords in the drum 1 tire falls by 10% from 3267 to 2940, with the obvious risk of innerliner 6 penetrating between the cords of body plies 5 at least at the shoulders of tire 2.

Variation III in TABLE II, however, shows that, if, as in Variation I, the DNO27 body ply is replaced with a DNO27 body ply with 28 cords per inch (about 11 per cm), drum 1 described above—i.e. with a diameter D1 increased to 36 in. (91.44 cm)—provides for obtaining a tire with a total number of 3167 cords and a perfectly acceptable cord loss of 3% with respect to the corresponding tire formed on a 40 in. (101.60 cm) diameter first-stage drum.

In other words, TABLE II shows that the diameter D1 of central body 16 of a normal unistage drum—i.e. of substantially constant diameter—need simply be increased to compensate for the differences in thickness between the central portion 11 and lateral portions 12 of carcass 3 to enable the drum, with all the advantages afforded by the unistage method, to produce a carcass 3 with substantially the same structural characteristics as a corresponding carcass produced using the two-stage method on a first-stage drum.

The invention is not limited to the above embodiments. What is claimed is:

1. A unistage drum for producing a farm vehicle radial tire (2); the tire (2) comprising a carcass (3) having a relatively thin central portion (11) and two thicker lateral portions (12); the drum (1) comprising a fixed central body (16) for supporting the central portion (11) of said carcass (3) and having a first outside diameter (D1), and two half-drums (15), each for supporting a respective said lateral portion (12) of said carcass (3); and wherein said half-drums (15) are located on opposite sides of said central body (16) and are movable axially to and from the central body (16); and each said half-drum (15) comprises an expandable bead clamping device (23) adjacent to said central body (16); and wherein at least one portion of each said half-drum (15) extends outwards with respect to the relative said bead clamping device (23) and has a second diameter (D2) smaller than said first diameter (D1) to at least compensate for the differences in thickness between said central portion (11) and said lateral portions (12) of said carcass (3) when the carcass (3) is laid flat on the drum (1).

2. A drum as claimed in claim 1, wherein each said half-drum (15) comprises a tubular body (19) located partly outwards of the relative said bead clamping device (23); and at least one annular bladder (31, 34) coaxial with said tubular body (19) and lying, at rest, on the tubular body (19); said second diameter (D2) being equal to a diameter of said tubular body (19) plus twice a thickness of said bladder (31, 34) at rest.

3. A drum as claimed in claim 1, wherein each said half-drum (15) comprises a tubular body (19) located partly outwards of the relative said bead clamping device (23) and having a cylindrical outer surface (20); a first annular thrust bladder (31) coaxial with said tubular body (19) and lying, at rest, on and in contact with said outer surface (20); and a second annular turn-up bladder (34) coaxial with said tubular body (19) and lying, at rest, outwards of and in contact with said first bladder (31); said second diameter (D2) being equal to a diameter of said tubular body (19) plus twice a total thickness of said bladders (31, 34) at rest.

4. A drum as claimed in claim 2, wherein each said half-drum (15) comprises a tubular body (19) located partly outwards of the relative said bead clamping device (23) and having a cylindrical outer surface (20); a first annular thrust bladder (31) coaxial with said tubular body (19) and lying, at rest, on and in contact with said outer surface (20); and a second annular turn-up bladder (34) coaxial with said tubular body (19) and lying, at rest, outwards of and in contact with said first bladder (31); said second diameter (D2) being equal to a diameter of said tubular body (19) plus twice a total thickness of said bladders (31, 34) at rest.

5. A drum as claimed in claim 1, wherein said first diameter (D1) differs from said second diameter (D2) by about 5 cm.

6. A drum as claimed in claim 2, wherein said first diameter (D1) differs from said second diameter (D2) by about 5 cm.

7. A drum as claimed in claim 3, wherein said first diameter (D1) differs from said second diameter (D2) by about 5 cm.

8. A drum as claimed in claim 4, wherein said first diameter (D1) differs from said second diameter (D2) by about 5 cm.
